(19) United States
(12) Patent Application Publication
(10) Pub. No.: US 2011/0181519 A1
(43) Pub. Date: Jul. 28, 2011

(54) System and method of driving a touch screen

(75) Inventors: Kun-Hua Tsai, Tainan (TW); Kai-Lan Chuang, Tainan (TW)

(73) Assignee: HIMAX TECHNOLOGIES LIMITED, Tainan (TW)

(21) Appl. No.: 12/694,175

(22) Filed: Jan. 26, 2010

(51) Int. Cl. G06F 3/041; G09G 5/00

(52) U.S. Cl. 345/173; 345/204

(57) ABSTRACT

A system of driving a touch screen comprises a touch sensitive panel including a plurality of first sensor lines parallel to a first direction and a plurality of second sensor lines parallel to a second direction, a driving circuit coupled with the first sensor lines, a first sensing circuit, and a controller coupled with the first sensing circuit. The driving circuit is configured to sequentially apply a first scanning signal through each of the first sensor lines. The first sensing circuit can report a plurality of first response signals that are transmitted through the second sensor lines in response to each applied first scanning signal. The controller can identify one or more touch location based on the first response signals reported by the first sensing circuit, and track each identified touch location. In other embodiments, methods of driving a touch screen are also described.

### FIELD OF THE INVENTION

The present invention relates to touch screen devices, and more particularly to a system and method of driving a touch screen.

### DESCRIPTION OF THE RELATED ART

Because touch sensitive panels are more user-friendly to operate, display systems increasingly incorporate touch sensitive panels as replacements to conventional keyboard and/or mouse devices. For example, a user can execute a complex sequence of instructions by simply pressing the touch screen at a location identified by a displayed icon. The location of each touch applied by a user can be determined by measuring separate signals generated by the touch input and then comparing the signals or ratios of the signals to calculate the position where the touch occurs.

While the conventional touch screen system can effectively detect each singly touched location, erroneous detection may occur when multiple touches are concurrently applied. For example, in case first and second touch locations are pressed in a same time interval (i.e., the first and second touches temporally overlap), a set of signals are usually generated for determining the multiple touch locations. However, because these signals are usually resulting from the superposition of different signals corresponding to each of the first and second touch, the use of the detected set of signals for inferring the touch locations may lead to erroneous calculation of “phantom” touch locations that were not actually touched. As a result, false user inputs may be transmitted to the computing device coupled with the touch screen when multiple touches occur concurrently.

Therefore, there is presently a need for a system and method of driving a touch screen that can detect multiple concurrent touch locations in an accurate manner, and address the foregoing issues.

### SUMMARY

The present disclosure describes a system and method of driving a touch screen. In one embodiment, the system of driving a touch screen comprises a touch sensitive panel including a plurality of first sensor lines parallel to a first direction and a plurality of second sensor lines parallel to a second direction, a driving circuit coupled with the first sensor lines, a first sensing circuit, and a controller coupled with the first sensing circuit. The driving circuit is configured to sequentially apply a first scanning signal through each of the first sensor lines. The first sensing circuit can report a plurality of first response signals that are transmitted through the second sensor lines in response to each applied first scanning signal. The controller can identify one or more touch location based on the first response signals reported by the first sensing circuit, and track each identified touch location.

In some embodiments, the method of driving a touch screen comprises performing a plurality of successive scanning cycles through the touch sensitive panel, and tracking each identified touch location through the successive scanning cycles. Each of the scanning cycles can comprise applying a scanning signal one at a time through each of the first sensor lines, for each applied scanning signal identifying one or more touch location on the touch sensitive panel based on a plurality of response signals read through the second sensor lines, and tracking each identified touch location through the successive scanning cycles.

In other embodiments of the method of driving a touch screen, each of the scanning cycles can comprise applying a first scanning signal one at a time through each of the first sensor lines, applying a second scanning signal one at a time through each of the second sensor lines, for each first scanning signal applied on one first sensor line, identifying one or more touch location on the touch sensitive panel based on a plurality of first response signals read through the second sensor lines, and for each second scanning signal applied on one second sensor line, identifying one or more touch location on the touch sensitive panel based on a plurality of second response signals read through the first sensor lines.

Because each sensor line is scanned sequentially one at a time, the occurrence of multiple concurrent touch locations can be identified in an accurate manner, and erroneous determination of phantom touch locations can be advantageously prevented.

### BRIEF DESCRIPTION OF THE DRAWINGS

FIG. 1 is a schematic diagram illustrating one embodiment of a touch screen system;

FIG. 2 is a schematic diagram illustrating an operation of the touch screen system shown in FIG. 1;

FIG. 3A is a flowchart illustrating method steps for driving the touch screen system shown in FIG. 2 according to one embodiment of the present invention;

FIG. 3B is a flowchart of method steps implemented in one scanning cycle for identifying touch location(s) on the touch sensitive panel shown in FIG. 2, according to one embodiment of the present invention;

FIG. 4 is a schematic diagram illustrating another embodiment of a touch screen system;

FIG. 5A is a flowchart of method steps for driving the touch screen system shown in FIG. 4 according to one embodiment of the present invention; and

FIG. 5B is a flowchart of method steps implemented in one scanning cycle for identifying touch location(s) on the touch sensitive panel shown in FIG. 4, according to one embodiment of the present invention.

### DETAILED DESCRIPTION OF THE EMBODIMENTS

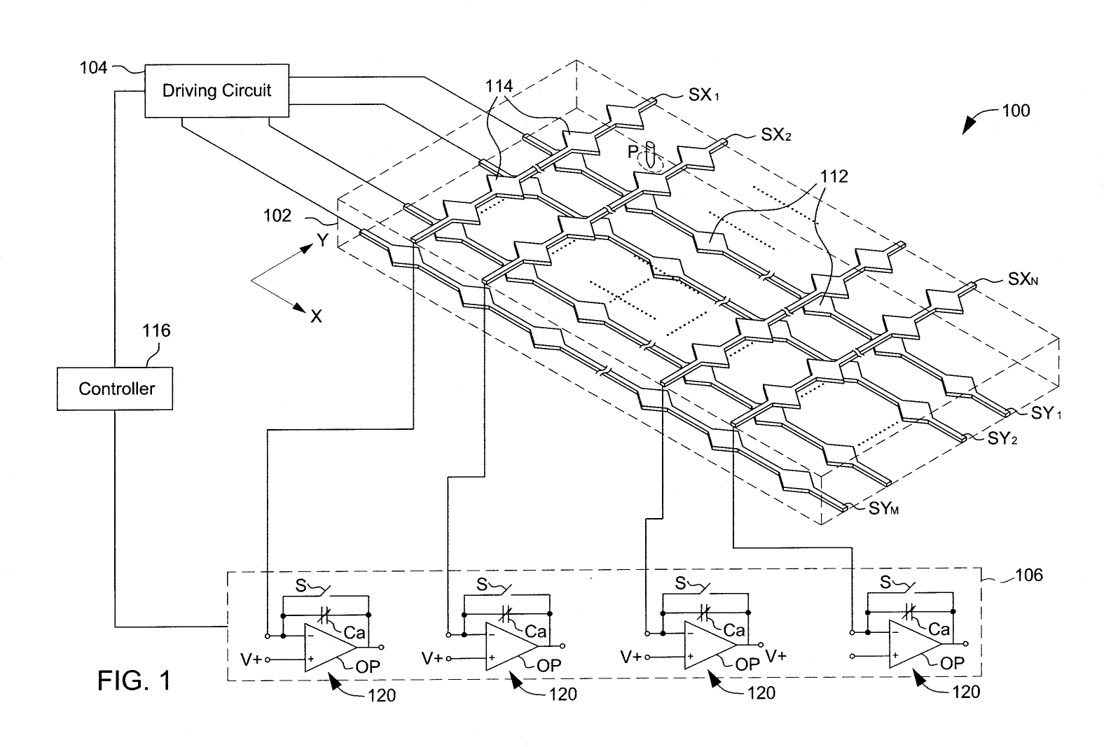

FIG. 1 is a schematic diagram illustrating one embodiment of a touch screen system 100. Examples of application for the touch screen system 100 can include touch sensitive display devices such as desktop monitors, display screens of for cellular phone, laptop display screens, and the like. The touch screen system 100 can include a touch sensitive panel 102, a driving circuit 104, and a sensing circuit 106.

The touch sensitive panel 102 can include a plurality of spaced-apart first electrodes 112 that are laid along a plurality of parallel rows in a first direction X, and a plurality of spaced-apart second electrodes 114 that are laid along a plurality of parallel columns in a second direction Y perpendicular to the first direction X. The touch sensitive panel 102 can also include a plurality of first sensor lines SY₁-SY_{M} parallel to the first direction X, and a plurality of second sensor lines SX₁-SX_{N} parallel to the second direction Y. Each of the first sensor lines SY₁-SY_{M} is coupled with a plurality of first electrodes 112 laid on a first plane, and each of the second sensor lines SX₁-SX_{N} is coupled with a plurality of second electrodes 114 laid on a second plane parallel to the first plane. The first electrodes 112 and second electrodes 114 can be patterned from two parallel spaced-apart layers made of a transparent conducting material, such as indium-tin-oxide, indium-zinc oxide or the like, and separated by a dielectric layer. Each row of the first electrodes 112 is electrically coupled with a distinct one of the first sensor line SY₁-SY_{M}, wherein M is an integer representing the total number of first sensor lines parallel to the first direction X. Each column of the second electrodes 114 is electrically coupled with a distinct one of the second sensor line SX₁-SX_{N}, wherein N is an integer representing the total number of second sensor lines parallel to the second direction Y.

The first sensor lines SY₁-SY_{M} are electrically coupled with the driving circuit 104, and the second sensor lines SX₁-SX_{N} are electrically coupled with the sensing circuit 106. The arrangement of the first and second electrodes 112 and 114 and associated sensor lines, which defines a coordinate system (X, Y) of the touch screen panel 102, forms a multipoint sensing array that can detect and monitor touches at distinct points across a touch sensitive surface of the touch sensitive panel 102. In addition, the driving circuit 104 and the sensing circuit 106 can be connected with a controller 116. The controller 116 can determine and identify one or more location on the touch sensitive panel 102 where a touch event occurs based on response signals reported by the sensing circuit 106, and track each identified touch location.

As shown, the sensing circuit 106 can include a plurality of read units 120, each of which is coupled with one of the second sensing lines SX₁-SX_{N} for reporting the response signals transmitted through each of the second sensor lines SX₁-SX_{N} in response to the application of a scanning signal through one of the first sensor lines SY₁-SY_{M}. In one embodiment, each of the read units 120 can include an integrator circuit. The integrator circuit can comprises an operational amplifier OP having a non-inverting input and an output, a variable capacitor Ca and a switch S. The non-inverting input of the operational amplifier OP can be coupled with a reference voltage V+. The variable capacitor Ca and switch S can be respectively coupled in parallel between the inverting input and the output of the operational amplifier OP. In addition, the inverting input of the operational amplifier OP can be coupled with an associated one of the second sensor lines. Each of the read units 120 can transform a received current signal to a voltage signal reflecting capacitive coupling between the first and second electrodes 112 and 114.

During operation, the driving circuit 104 can apply an electric signal S in a sequential manner through each of the first sensor lines SY₁-SY_{M} during one scanning period of time. Owing to capacitive coupling, response signals are accordingly transmitted through the second sensor lines SX₁-SX_{N}, and read by the read units 120 of the sensing circuit 106 When a touch event occurs at a given touch location P on the touch sensitive panel 102, it can cause a change in the capacitive coupling between a neighboring pair of the first and second electrodes 112 and 114 adjacent to the touch location P. The change in capacitance coupling can be detected from a characteristic response signal that is transmitted through the corresponding second sensor line (e.g., second sensor line SX₂) associated with the neighboring pair of the first and second electrodes 112 and 114, when the first scanning signal S is applied through the corresponding first sensor line (e.g., first sensor line SY₁) associated with the neighboring pair of the first and second electrodes 112 and 114.

For detecting the occurrence of multiple touch points, the controller 116 can include an internal register that can keep track of all the touch locations identified during each scanning period of time.

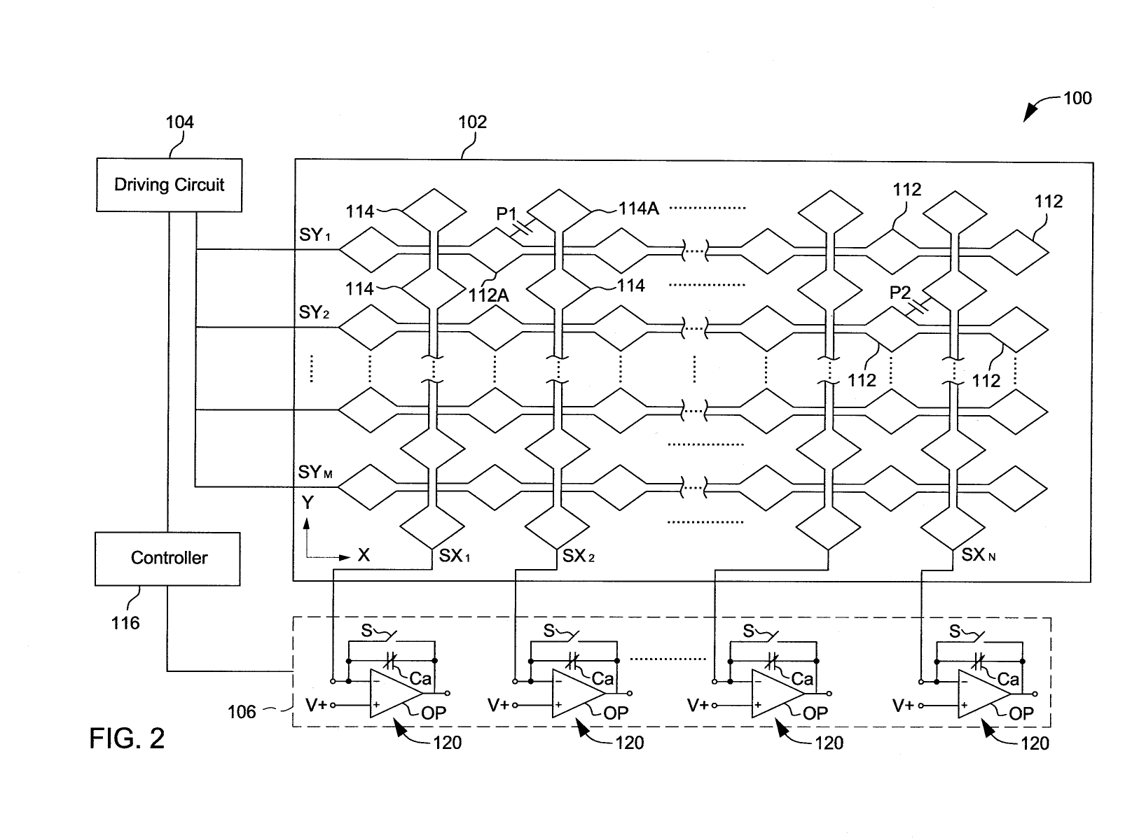

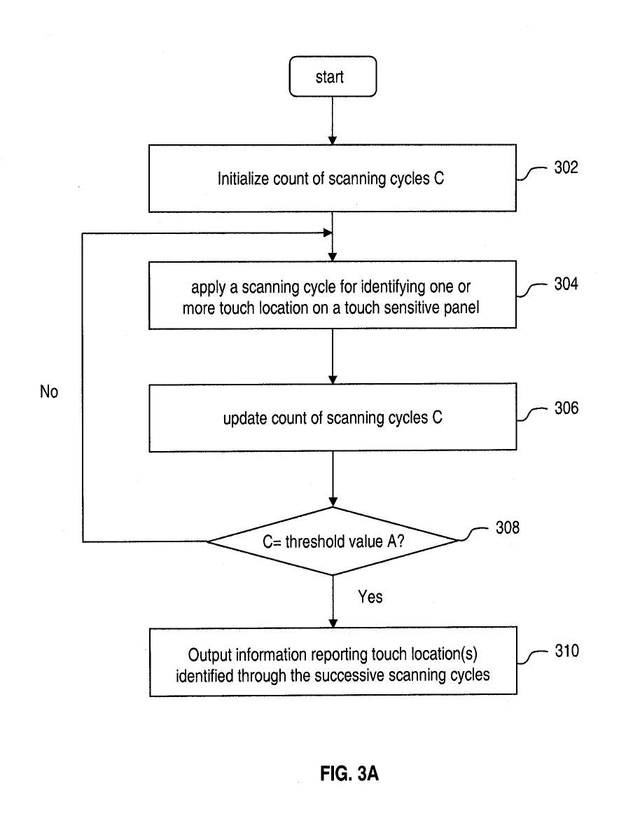

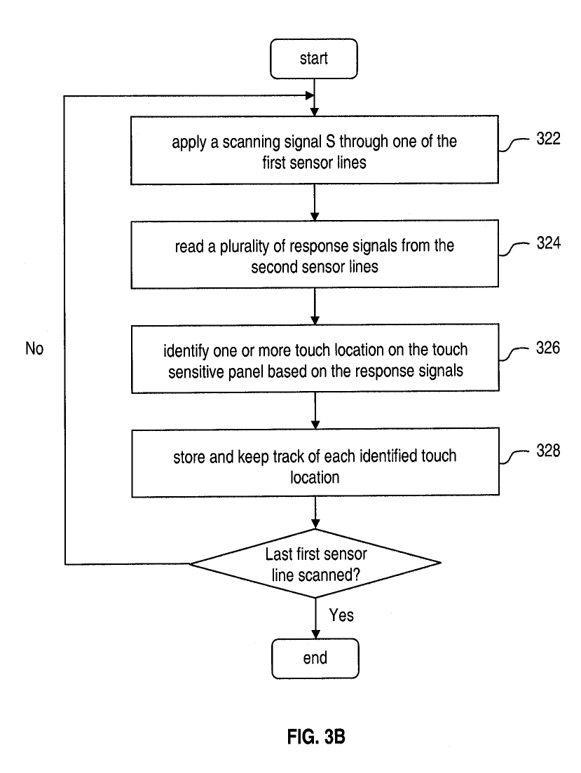

In conjunction with the diagram of FIG. 2, FIG. 3A is a flowchart illustrating method steps for driving the touch screen system 100 according to one embodiment of the present invention. In initial step 302, the controller 116 can initialize a count of scanning cycles C that tracks a total number of scanning cycles currently processed. In one embodiment, the count of scanning cycles C may be initialized to the value 0. In alternate embodiments, the count of scanning cycles C can also be initialized to a predetermined value greater than 0. In next step 304, a scanning cycle is then applied through the touch sensitive panel 102 for identifying one or more touch location occurring on the touch sensitive panel 102.

In step 306, the controller 116 can then update the count of scanning cycles C. If the count of scanning cycles C is initially set to 0 in step 302, the count of scanning cycles C can be updated by incrementing by 1 after each scanning cycle is completed. In case the count of scanning cycles C is initially set to a value greater than 0 in step 302, the count of scanning cycles C may updated by decrementing by 1 after each scanning cycle is completed. Subsequently, in step 308, the controller 116 can determine whether the count of scanning cycles C is equal to a predetermined threshold value A that sets a window of scanning cycles for periodically reporting touch locations. If the count of scanning cycles C is not equal to the threshold value A, steps 304-308 are repeated for a next scanning cycle. In this manner, successive scanning cycles can be repeated through the touch sensitive panel 102. In case the count of scanning cycles C is equal to the threshold value A, the controller 116 in step 310 can output information reporting the touch location(s) identified through the successively performed scanning cycles.

FIG. 3B is a flowchart of method steps implemented in the scanning cycle of step 304 for identifying one or more touch location(s) on the touch sensitive panel 102, according to one embodiment of the present invention. In step 322, a scanning signal S (e.g., an electric pulse) is applied one at a time through one of the first sensor lines (e.g., first sensor line SY₁) along the first direction Y. In next step 324, as a result of the applied scanning signal S, a plurality of response signals are read through all of the second sensor lines SX₁-SX_{N} via the sensing circuit 106. In next step 326, based on the response signals reported by the sensing circuit 106, the controller 116 can identify any location along the first sensor line SY₁ where a touch occurs, and accordingly associate coordinate values with each identified touch location.

As described previously, the step 326 of identifying one or more touch location may comprise detecting the change in capacitance coupling from the response signal that is transmitted through the second sensor line SX₁-SX_{N} associated with the neighboring pair of the first and second electrodes 112 and 114, when the scanning signal is applied through the first sensor line SY₁-SY_{M} associated with the neighboring pair of the first and second electrodes 112 and 114. For example, with reference to FIG. 2, suppose a touch event occurs at location P1 while the scanning signal S is applied through the first sensor line SY₁ at time t1. Owing to a change in the capacitive coupling between a pair of adjacent first electrode 112A coupled with the first sensor line SY₁ and neighboring second electrode 114A coupled with the second sensor line SX₂, the response signal transmitted through the second sensor line SX₂ will have a magnitude that differs from a response signal conveying no touch occurrences. By identifying which of the second sensor lines SX₁-SX_{N} transmits a response signal characteristic of a touch event, the controller 116 can thus identify and associate a pair of coordinate values for each touch location along the scanned first sensor line SY₁ (e.g., coordinate values (X₂, Y₁) for the location P1).

In next step 328, the controller 116 can then keep track of each identified touch location by storing in an internal register the associated coordinate values (e.g., coordinate values (X₂, Y₁) for the location P1). If the first sensor line currently scanned is not the last first sensor line SY_{M}, steps 322-328 can be repeated for a next first sensor line. For example, after the first sensor line SY₁ is scanned at time t1, a scanning signal S can be applied on the next first sensor line SY₂ at time t2 subsequent to t1, and a plurality of response signals through the second sensor lines SX₁-SX_{N} can be accordingly detected via the sensing circuit 106. Suppose a touch event occurs at time t2 at a location P2 adjacent to the intersection between the first sensor line SY₂ and the second sensor line SX_{N}. The controller 116 can accordingly identify the touch location P2 via the response signal transmitted through the corresponding second sensor line SX_{N}, associate the coordinate values (X_{N}, Y₂) with the touch location P2, and store the coordinates (X_{N}, Y₂).

One scanning cycle can be accomplished by repeatedly applying steps 322-328 for sequentially scanning all of the first sensor lines SY₁-SY_{M} over a horizontal period of time T_{H}.

Because each first sensor line is scanned sequentially one at a time, erroneous detection of phantom touch locations can be prevented. In addition, as the scanning frequency 1/T_{H} is set much faster than the hold time of the touch during which the touch is generally held, the occurrence of multiple touch locations substantially at the same time (e.g., the touch events at locations P1 and P2 can occur in a same interval of time) can thus be distinctly identified in an effective manner through the successive scanning cycles.

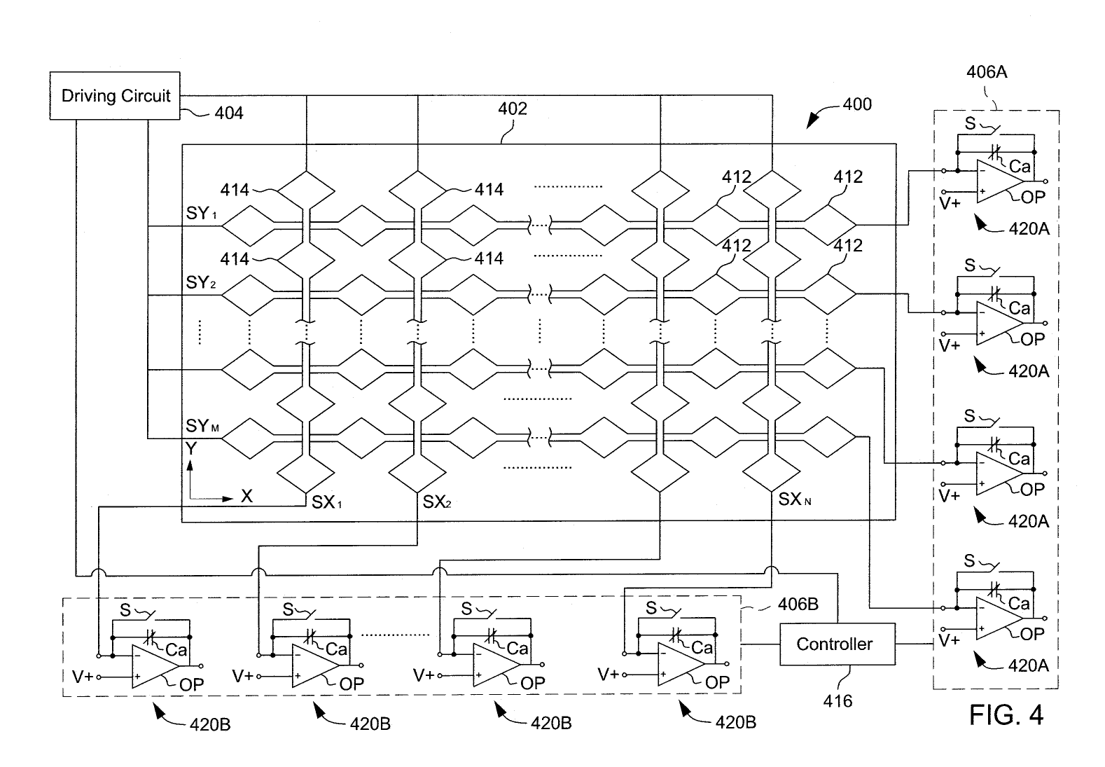

FIG. 4 is a schematic diagram illustrating another embodiment of a touch screen system 400. The touch screen system 400 can include a touch sensitive panel 402, a driving circuit 404, first and second sensing circuits 406A and 406B, and a controller 416. The touch sensitive panel 402 can include a plurality of spaced-apart first electrodes 412 that are laid along a plurality of rows parallel to a first direction X, and a plurality of spaced-apart second electrodes 414 that are laid along a plurality of columns parallel to a second direction Y perpendicular to the first direction X. The driving circuit 404 can be coupled with the first sensor lines SY₁-SY_{M} to sequentially apply a first scanning signal S1 through each of the first sensor lines SY₁-SY_{M}. In addition, the driving circuit 404 can be coupled with each of the second sensor lines SX₁-SX_{N}, and the first sensor lines SY₁-SY_{M} can be coupled with the second sensing circuit 406B. The driving circuit 404 can also sequentially apply a second scanning signal S2 through each of the second sensor lines SX₁-SX_{N}, and the second sensing circuit 406B can report second response signals that are transmitted through the first sensor lines SY₁-SY_{M} in response to each applied second scanning signal S2.

The first sensing circuit 406A includes a plurality of first read units 420A, and the second sensing circuit 406B includes a plurality of second read units 420B. Each of the first sensor line SY₁-SY_{M} that is coupled with one distinct row of the first electrodes 412 is respectively coupled with the driving circuit 404 and one first read unit 420A of the first sensing circuit 406A. In the same manner, each of the second sensor lines SX₁-SX_{N} that is coupled with one distinct column of the second electrodes 414 is also coupled with the driving circuit 404 and one second read unit 420B of the second sensing circuit 406B. In one embodiment, each of the first and second read units 420A and 420B may include an integrator circuit as described previously. With this configuration, both horizontal and vertical scanning of the touch screen panel 402 can be implemented.

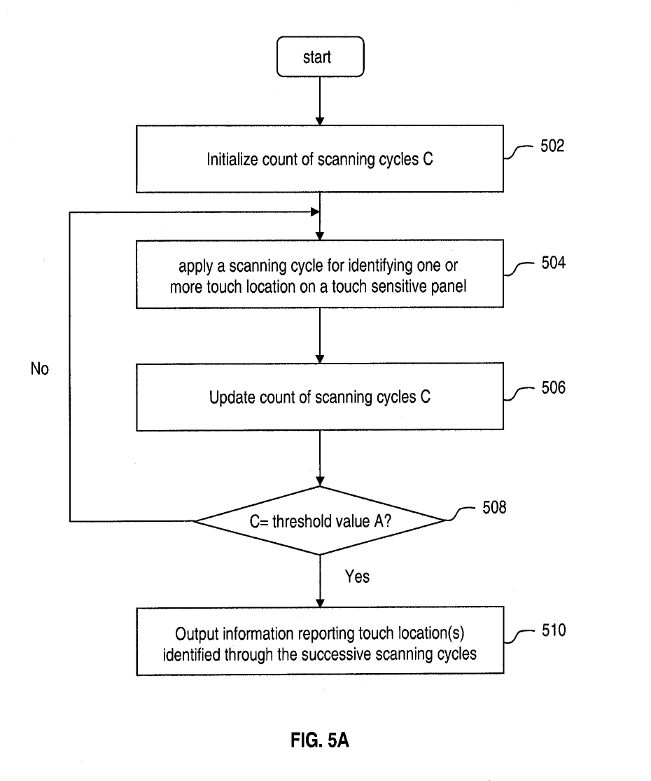

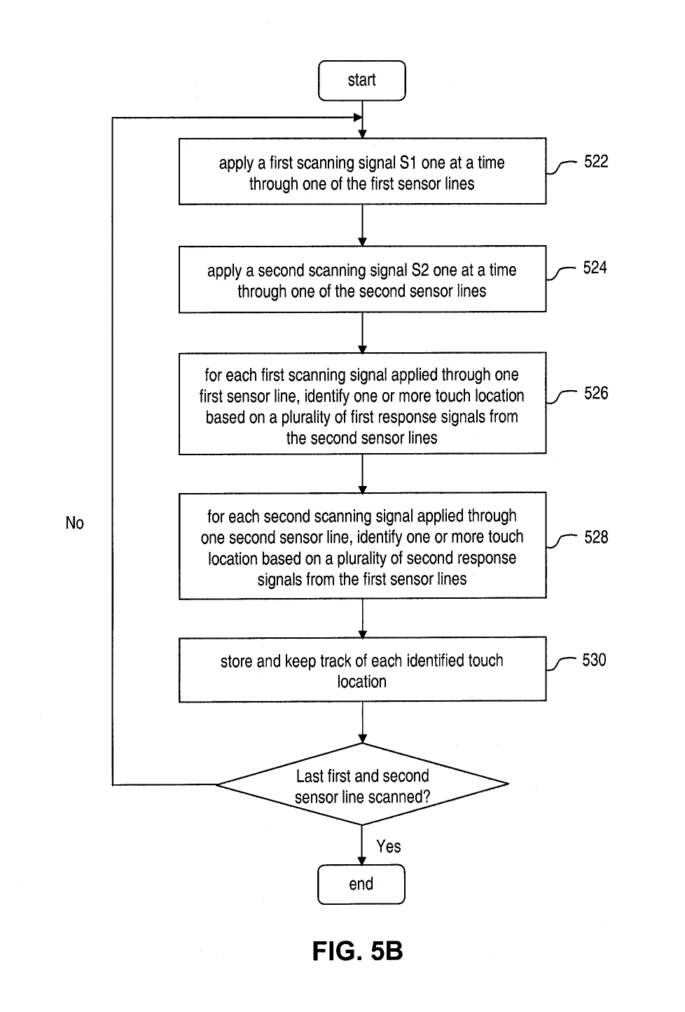

In conjunction with FIG. 4, FIG. 5A is a flowchart of method steps for driving the touch screen system 400 according to one embodiment of the present invention. In initial step 502, the controller 416 can initialize a count of scanning cycles C that tracks a total number of scanning cycles currently processed. In one embodiment, the count of scanning cycles C may be initialized to the value 0. In alternate embodiments, the count of scanning cycles C can also be initialized to a predetermined value greater than 0.

In next step 504, a scanning cycle is then applied through the touch sensitive panel 402 for identifying one or more touch location occurring on the touch sensitive panel 402. In step 506, the controller 416 can then update the count of scanning cycles C. If the count of scanning cycles C is initially set to 0 in step 502, the count of scanning cycles C can be updated by incrementing by 1 after each scanning cycle is completed. In case the count of scanning cycles C is initially set to a value greater than 0 in step 502, the count of scanning cycles C may updated by decrementing by 1 after each scanning cycle is completed. Subsequently, in step 508, the controller 416 can determine whether the count of scanning cycles C is equal to a predetermined threshold value A that sets a window of scanning cycles for periodically reporting touch locations. If the count of scanning cycles C is not equal to the threshold value A, steps 504-508 are repeated for a next scanning cycle. In this manner, successive scanning cycles can be repeated through the touch sensitive panel 102. In case the count of scanning cycles C is equal to the threshold value A, the controller 416 in step 510 can output information reporting the touch location(s) identified through the successively performed scanning cycles.

FIG. 5B is a flowchart of method steps implemented in the scanning cycle of step 502 for identifying touch location(s) on the touch sensitive panel 402, according to one embodiment of the present invention. In step 522, the driving circuit 404 can apply a first scanning signal S1 one at a time through one of the first sensor lines SY₁-SY_{M}. In step 524, the driving circuit 404 can also apply a second scanning signal S2 one at a time through one of the second sensor lines SX₁-SX_{N}. It is worth noting that steps 522 and 524 may be performed concurrently, or in any order.

In step 526, for each first scanning signal S1 applied through one of the first sensor lines SY₁-SY_{M}, the controller 416 can identify one or more touch location based on a plurality of first response signals from the second sensor lines SX₁-SX_{N}. As described previously, the first response signals can be read from the second sensor lines SX₁-SX_{N} via the second read units 420B. In step 528, for each second scanning signal S2 applied through one of the second sensor lines SX₁-SX_{N}, the controller 416 can identify one or more touch location based on a plurality of second response signals from the first sensor lines SY₁-SY_{M}. As described previously, the second response signals can be read from the first sensor lines SY₁-SY_{M} via the first read units 420A. In step 530, the controller 416 can then store and keep track of each identified touch location by storing in an internal register the coordinate values associated with each touch location based on the first and second response signals. Steps 522-530 can be repeatedly applied until the scanning of all of the first and second sensor lines SY₁-SY_{M} and SX₁-SX_{N} is achieved to complete one scanning cycle.

It is worth noting that the application of each first and second scanning signal S1 and S2 may be conducted concurrently on a pair of the first and second sensor lines, or in alternate order. In case the applied scanning cycle is performed in alternate order, the second scanning signals S2 may be applied through the second sensor lines SX₁-SX_{N} after all of the scanning of the first second sensor lines SY₁-SY_{M}. In alternate embodiments, each of the first and second sensor lines can also be scanned one-by-one in alternate order.

With a scanning cycle that scans through two directions of sensor lines, multiple concurrent touch locations can be distinctly identified in a more accurate manner as cross comparison can be made on touch locations identified through horizontal and vertical scanning. In addition, because each sensor line in one given direction is scanned one at a time, erroneous detection of phantom touch locations can also be advantageously prevented.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Structures and functionality presented as discrete components in the exemplary configurations may be implemented as a combined structure or component. These and other variations, modifications, additions, and improvements may fall within the scope of the invention as defined in the claims that follow.

What is claimed is:

1. A system of driving a touch screen, the system comprising:
a touch sensitive panel including a plurality of first sensor lines parallel to a first direction, and a plurality of second sensor lines parallel to a second direction;
a driving circuit coupled with the first sensor lines, wherein the driving circuit is configured to sequentially apply a first scanning signal through each of the first sensor lines;
a first sensing circuit for reporting a plurality of first response signals that are transmitted through the second sensor lines in response to each applied first scanning signal; and
a controller configured to:
identify one or more touch location based on the first response signals reported by the first sensing circuit, and
track each identified touch location.

2. The system according to claim 1, wherein the sensing circuit includes a plurality of integrator circuits respectively coupled with the second sensor lines.

3. The system according to claim 2, wherein each of the integrator circuits comprises:
an operational amplifier having a non-inverting input, an inverting input and an output, wherein the non-inverting input is coupled with a reference voltage; and
a variable capacitor and a switch respectively coupled in parallel between the inverting input and the output of the operational amplifier.

4. The system according to claim 3, wherein the inverting input of the operational amplifier is coupled with one of the second sensor lines.

5. The system according to claim 1, wherein each of the first sensor lines is coupled with a plurality of first electrodes laid on a first plane, and each of the second sensor lines is coupled with a plurality of second electrodes laid on a second plane parallel to the first plane.

6. The system according to claim 5, wherein the occurrence of a touch event at a touch location on the touch sensitive panel causes a change in capacitance coupling between a neighboring pair of the first and second electrodes that is adjacent to the touch location.

7. The system according to claim 6, wherein the change in capacitance coupling is detected from the first response signal that is transmitted through the second sensor line associated with the neighboring pair of the first and second electrodes, when the first scanning signal is applied through the first sensor line associated with the neighboring pair of the first and second electrodes.

8. The system according to claim 1, wherein the driving circuit is further coupled with each of the second sensor lines, and the first sensor lines are further coupled with a second sensing circuit.

9. The system according to claim 8, wherein the driving circuit is further configured to sequentially apply a second scanning signal through each of the second sensor lines, and the second sensing circuit is adapted to report second response signals that are transmitted through the first sensor lines in response to each applied second scanning signal.

10. The system according to claim 9, wherein the controller is further configured to identify and track each touch location on the touch sensitive panel based on the first and second response signals.

11. A method of driving a touch screen system, wherein the touch screen system includes a touch sensitive panel having a plurality of spaced-apart first sensor lines laid parallel to a first direction and a plurality of spaced-apart second sensor lines laid parallel to a second direction, the method comprising:
performing a plurality of successive scanning cycles through the touch sensitive panel, wherein each of the scanning cycles comprises:
applying a scanning signal one at a time through each of the first sensor lines;
for each applied scanning signal, identifying one or more touch location on the touch sensitive panel based on a plurality of response signals read through the second sensor lines; and
tracking each identified touch location through the successive scanning cycles.

12. The method according to claim 11, wherein the second sensor lines are respectively coupled with a plurality of integrator circuits through which the response signals are read for each applied scanning signal.

13. The method according to claim 11, wherein each of the first sensor lines is coupled with a plurality of first electrodes laid on a first plane, and each of the second sensor lines is coupled with a plurality of second electrodes laid on a second plane parallel to the first plane.

14. The method according to claim 13, wherein the occurrence of a touch event at a touch location on the touch sensitive panel causes a change in capacitance coupling between a neighboring pair of the first and second electrodes that is adjacent to the touch location.

15. The method according to claim 14, wherein the step of identifying one or more touch location comprises detecting the change in capacitance coupling from the response signal that is transmitted through the second sensor line associated with the neighboring pair of the first and second electrodes, when the scanning signal is applied through the first sensor line associated with the neighboring pair of the first and second electrodes.

16. A method of driving a touch screen system, wherein the touch screen system includes a touch sensitive panel having a plurality of first sensor lines parallel to a first direction and a plurality of second sensor lines parallel to a second direction, the method comprising:
performing a plurality of successive scanning cycles through the touch sensitive panel, wherein each of the scanning cycles comprises:
applying a first scanning signal one at a time through each of the first sensor lines;
applying a second scanning signal one at a time through each of the second sensor lines;
for each first scanning signal applied on one first sensor line, identifying one or more touch location on the touch sensitive panel based on a plurality of first response signals read through the second sensor lines;
for each second scanning signal applied on one second sensor line, identifying one or more touch location on the touch sensitive panel based on a plurality of second response signals read through the first sensor lines; and
tracking each identified touch location on the touch sensitive panel through the successive scanning cycles.

17. The method according to claim 16, wherein the first and second sensor lines are respectively coupled with a plurality of integrator circuits.

18. The method according to claim 16, wherein each of the first sensor lines is coupled with a plurality of first electrodes laid on a first plane, and each of the second sensor lines is coupled with a plurality of second electrodes laid on a second plane parallel to the first plane.

19. The method according to claim 18, wherein the occurrence of a touch event at a touch location on the touch sensitive panel causes a change in capacitance coupling between a neighboring pair of the first and second electrodes that is adjacent to the touch location.

20. The method according to claim 19, wherein the step of identifying one or more touch location based on the response signals comprises detecting the change in capacitance coupling from the response signal that is transmitted through the second sensor line associated with the neighboring pair of the first and second electrodes, when the scanning signal is applied through the first sensor line associated with the neighboring pair of the first and second electrodes.
